(19) United States
(12) Patent Application Publication
(10) Pub. No.: US 2012/0299218 A1
(43) Pub. Date: Nov. 29, 2012

(54) COMPOSITE ACTIVE MOLDS AND METHODS OF MAKING ARTICLES OF SEMICONDUCTING MATERIAL

(76) Inventors: Glen Bennett Cook, Elmira, NY (US); Prantik Mazumder, Ithaca, NY (US); Balram Suman, Katy, TX (US); Natesan Venkataraman, Painted Post, NY (US)

(21) Appl. No.: 13/117,440

(22) Filed: May 27, 2011

(51) Int. Cl. B28B 1/38; B28B 7/42

(52) U.S. Cl. 264/327; 264/319; 425/275

(57) ABSTRACT

The disclosure relates to a substrate mold comprising a shell material having an external surface configured to engage with molten semiconducting material, and an internal surface configured as a thermal transfer surface to transfer heat therethrough, and a core defined within the shell material and configured to remove heat from the shell material through the thermal transfer surface of the shell material. The substrate mold is configured to be immersed into the molten semiconducting material, and the external surface of the shell material is configured to have solidified molten semiconducting material formed thereon.

### FIELD OF THE INVENTION

The disclosure relates generally to substrate molds configured to form articles of solid semiconducting material from molten semiconducting material, and methods of making articles of semiconducting material, and more particularly to substrate molds comprising a shell material having an external surface to form semiconducting material thereon, where the substrate mold further comprises a core within the shell material configured to remove heat from the shell material.

### BACKGROUND

Two widely-used techniques for producing silicon wafers are classical crystal growth techniques—float zone and Czokralski. Both methods can be used to produce high quality single or poly-crystalline silicon ingots. The ingots are wire sawed to provide wafers of desired thicknesses. However, due to the finite thickness of the wire saw, a significant fraction of the material is lost (kerf loss) during cutting. The amount of lost material could be as high as 50 percent. Therefore, directly forming a free standing silicon film having a desired final or near final net shape that obviates the sawing step would reduce material loss due to wiring sawing.

Thin film deposition techniques such as chemical vapor deposition (CVD) and plasma chemical vapor deposition (PCVD) are viable alternatives. However, these processes are expensive and complex. Another group of processes are ribbon growth processes, including vertical ribbon growth processes and horizontal ribbon growth processes. Vertical ribbon growth processes, such as edge-defined, film-fed growth (EFG) and string ribbon (SR), operate at low pull speed and low throughput. Horizontal ribbon growth processes, such as molded wafer (MW) and ribbon growth on substrate (RGS) operate at high pull speed and throughput. Ribbon growth technologies can be used to form a net shape silicon sheet that is 150-600 microns thick.

The modern ribbon growth technologies, including RGS and MW, are relatively fast processes where the solidification rate and/or temperature gradient at the liquid-solid interface are much higher than those in the ingot growth methods. In these fast ribbon growth processes, the throughput can be increased by increasing the pull speed. However, the increase in throughput at higher pull speed is typically offset by a decrease in the efficiency of the resulting solar cells due to the incorporation of a higher defect density at faster growth rates. Thus, an inverse relationship appears between the throughput of the ribbon technologies and the efficiencies of the solar cells made from these ribbons.

For various applications, it is desirable to provide a process of making articles of semiconducting material that offers low cost per unit area without compromising cell efficiency. The process of exocasting is a process by which a product such as, for example, a silicon photovoltaic substrate, is fabricated using molten silicon. A mold, for example one comprising refractory materials, may be dipped into molten silicon. The molten silicon solidifies onto the relatively cold surface of the mold. The mold is then removed from the molten silicon and the solidified material detached from the surface of the mold, thereby forming an exocasted product, such as a wafer for photovoltaic cells.

In commonly-owned U.S. Pat. No. 7,771,643, which is incorporated by reference herein in its entirety, an exocasting process is disclosed that may produce a silicon film of a desired shape. In the process, a high temperature ceramic substrate, such as silica or alumina, is immersed into molten silicon. The initial temperature of the substrate is less than the melt temperature of the silicon. Immediately following the immersion of the substrate into the molten silicon, solidification of silicon adjacent to the substrate surface takes place. The rate of solidification is principally controlled by the rate of removal from the molten silicon of the latent heat of solidification by the substrate. The solidification stops after the substrate temperature increases and its thermal capacity is exhausted. Beyond this point, remelting of the solid film takes place. The dynamics of solidification and remelting can be predicted by mathematical methods, and a desired film thickness can be obtained by holding the substrate in the liquid melt for a predetermined time. This exocasting process allows for controlled thickness of the silicon film and a high overall throughput.

Despite these advantages, the silicon grain structures developed in this rapid solidification process may not be ideal for at least certain applications, such as, for example, high efficiency photovoltaic modules. In particular, the rapid solidification process results in silicon film with dendritic microstructure, which may deleterious to developing high efficiency photovoltaic modules.

In the exocasting process disclosed in U.S. Pat. No. 7,771,643, as shown schematically in FIGS. 7-9, a substrate mold 200 is immersed in molten semiconducting material 202 and solidified material 204 is formed on the surface of the substrate mold 200. The solidification by the molten semiconducting material 202 occurs in two directions, one normal to the substrate (Vₓ) and one in the direction parallel to the plane of the substrate (V_{y}). The bulk temperature of the molten semiconducting material 202 far from the substrate mold 200 is about 1470° C. in a standard process, when the molten semiconducting material is silicon, for example. The temperature of the substrate mold 200 far above a melt interface, which is the interface between the substrate mold 200 and the molten semiconducting material 202, is typically about 400° C. The solid-liquid interface 206 is at melting point range of about 1410° C. to about 1414° C. Therefore, the temperature gradient is highly negative in the direction parallel to the substrate mold 200. If the temperature gradient, G (° C./cm), at the interface between the substrate 200 and the molten semiconducting material 202 is negative, then the solidification front is unconditionally unstable and leads to a dendritic morphology. The liquid just ahead of the solid-liquid interface 206 in region 208 is highly undercooled, and therefore the temperature gradient in the liquid adjacent to the interface 206 in this region 208 is highly negative, e.g., −500−1000° C. Therefore, the interface morphology in this direction is almost always dendritic in a standard exocasting process.

On the other hand, if the temperature gradient at the interface is positive, then the solid-liquid interface is stable and planar if the speed of formation is below the critical velocity, V_{crit}=αG, where a is a parameter that depends on the material properties. FIG. 8 shows the calculated V_{crit} of silicon for G>0, along with the x and y components of the solidification velocities and temperature gradients of the exocasting process. Since the parallel component, V_{y}, falls in the unstable region (G>0) (designated “NS” in FIG. 8), the interface morphology is dendritic. On the other hand, since the normal component is within the stable region (G>0,Vₓ^{<}V_{crit}) (designated “S” in FIG. 8), the interface morphology is planar.

The formation velocity of the dendrite tip along the surface of the substrate mold 200 is approximately equal to the substrate dip velocity, except in the opposite direction. The temperature gradient in the direction perpendicular to the substrate mold 200 away from the tip of the solidified semiconducting material 204 is always positive, and therefore the shape of the solid-liquid interface is always planar in that direction.

Thus, the different temperature gradients in two orthogonal directions, positive in the direction normal to the substrate mold 200 and negative in the direction parallel to the substrate mold, set the two distinctly different morphologies, i.e., planar and dendritic, respectively. Therefore, reduction and preferably elimination of the negative temperature gradient in the direction parallel to the surface of the substrate mold 200 would be preferred to create an optimal microstructure.

The inventors have now discovered ways to reduce or eliminate the solidification velocity component along the substrate surface into the direction of a negative temperature gradient, which may result in the generation of dendritic features in the formed wafers. Further, the inventors have discovered ways for solidified material to be formed substantially only in the direction normal to the substrate mold, which is the direction of a positive temperature gradient. The inventors have further discovered ways to prevent excessive undercooling on the surface of the substrate mold, and at the same time form the solidified material of desired thickness and within a desired time. Thus, the molds and methods disclosed herein may, in at least some embodiments, solve one or more of the above-noted problems, although one or more of the above-noted problems may not be solved in certain embodiments, yet such embodiments are intended to be within the scope of the disclosure.

### SUMMARY

In accordance with various exemplary embodiments of the disclosure are provided methods of making solid articles of semiconducting material. The methods include providing a substrate mold having a shell material, and a core defined within the shell material and configured to remove heat from the shell material. The methods further comprise immersing the substrate mold into molten semiconducting material, solidifying the molten semiconducting material onto an external surface of the shell material, and removing the solidified semiconducting material from the substrate mold.

Exemplary embodiments also relate to substrate molds comprising a shell material and a core material. The shell material has an external surface configured to thermally contact molten semiconducting material and an internal surface configured as a thermal transfer surface to transfer heat therethrough. The core defined within the shell material is configured to remove heat from the shell material through the thermal transfer surface of the shell material. Substrate molds according to the disclosure may be configured to be immersed in the molten semiconducting material, and the external surface of the shell material may be configured to have solidified molten semiconducting material formed thereon.

As used herein, the term “semiconducting material” includes materials that exhibit semiconducting properties, such as, for example, silicon, germanium, gallium arsenide, alloys thereof, compounds thereof, and mixtures thereof. In various embodiments, the semiconducting material may be pure (such as, for example, intrinsic or i-type silicon) or doped (such as, for example, silicon containing n-type or p-type dopants, such as phosphorous or boron, respectively).

As used herein, the phrase “article of semiconducting material” includes any shape or form of semiconducting material made using methods according to the disclosure. Examples of such articles include articles that are smooth or textured; articles that are flat, curved, bent, or angled; and articles that are symmetric or asymmetric. Articles of semiconducting materials may comprise forms such as, for example, sheets or tubes.

As used herein, the term “mold” or “substrate mold” means a physical structure that can influence the final shape of the article of semiconducting material. Molten or solidified semiconducting material need not actually physically contact a surface of the mold in the methods described herein, although in various embodiments contact may occur between a surface of the mold and the molten or solidified semiconducting material

As used herein, the phrases “external surface of the mold” and “external surface of the shell material” mean a surface of the mold that may be exposed to a molten semiconducting material upon immersion. For example, the interior surface of a tube-shaped mold may be an external surface if the interior surface can contact a molten semiconducting material when the mold is immersed.

As used herein, the phrases “external surface configured to engage with molten semiconducting material,” “external surface configured to have solidified molten semiconducting material formed thereon,” and “form a solid layer of semiconducting material over an external surface of the mold” and variations thereof, are intended to mean that semiconducting material from the molten semiconducting material solidifies (also referred to as “freezing” or “crystallizing”) on or near an external surface of the mold.

Forming a solid layer of semiconducting material over an external surface of the mold may, in some embodiments, include solidifying semiconducting material on a layer of particles that coat the external surface of the mold. In various embodiments, due to the temperature difference between the mold and the molten semiconducting material, the semiconducting material may solidify before the semiconducting material physically contacts the surface of the mold. When the semiconducting material solidifies before the semiconducting material physically contacts the mold, the solidified semiconducting material may, in some embodiments, subsequently come into physical contact with the mold or with particles coating the mold. The semiconducting material may solidify after physically contacting the external surface of the mold, or particles coating the surface of the mold, if present.

As used herein, the phrase “an internal surface configured as a thermal transfer surface to transfer heat therethrough” is intended to mean a surface of the mold or shell material that partially defines the core of the mold, is internal within the substrate mold with respect to the external surface of the mold or shell material, and has properties that allow the internal surface to transfer heat from the external surface of the mold or shell material to the core material.

Additional objects and advantages of the disclosure will be set forth in part in the description which follows, and in part will be obvious from the description, or may be learned by practice of the disclosure. The objects and advantages of the disclosure will be realized and attained by means of the elements and combinations particularly pointed out in the appended claims.

It is to be understood that both the foregoing general description and the following detailed description are exemplary and explanatory only and are not restrictive of the claims.

The accompanying drawings, which are incorporated in and constitute a part of this specification, illustrate exemplary embodiments of the disclosure and, together with the description, serve to explain the principles described herein.

### BRIEF DESCRIPTION OF THE DRAWINGS

FIG. 1 is a schematic illustration of a method of making an article of semiconducting material according to an exemplary embodiment;

FIG. 2 is a schematic illustration of an exemplary substrate mold and a method of making an article of semiconducting material according to an exemplary embodiment;

FIG. 3 is a representative calculated plot of the thickness of a silicon article at various starting temperatures of a shell material and a first core material of the substrate mold as a function of the immersion time in molten silicon;

FIG. 4 is a representative calculated plot of the thickness of a silicon article at various starting temperatures of a shell material and a second core material of the substrate mold as a function of the immersion time in molten silicon;

FIG. 5 is a representative calculated plot of the thickness of a silicon article at various starting temperatures of a shell material and a third core material of the substrate mold f as a function of the immersion time in molten silicon;

FIG. 6 is a representative calculated plot of the thickness of a silicon article at various starting temperatures and various heat flux levels as a function of the immersion time in molten silicon;

FIG. 7 is a schematic illustration of a method of making an article of semiconducting material;

FIG. 8 is a graph illustrating the temperature gradient and solidification rate of an example method; and

FIG. 9 is a schematic illustration of a method of making an article of semiconducting material.

### DETAILED DESCRIPTION

It is to be understood that both the foregoing general description and the following detailed description are exemplary and explanatory only and are not restrictive of the claims. Other embodiments will be apparent to those skilled in the art from consideration of the specification and practice of the embodiments disclosed herein.

In various exemplary embodiments of the disclosure are provided substrate molds comprising (i) a shell material having an external surface configured to engage with molten semiconducting material, and an internal surface configured as a thermal transfer surface to transfer heat therethrough, and (ii) a core defined within the shell material and configured to remove heat from the shell material through the thermal transfer surface of the shell material. The substrate mold may be configured to be immersed in the molten semiconducting material, and the external surface of the shell material is configured to have solidified molten semiconducting material formed thereon.

In further exemplary embodiments of the disclosure are provided methods of making articles of semiconducting material, said methods comprising providing a substrate mold having (i) a shell material and (ii) a core defined within the shell material configured to remove heat from the shell material, immersing the substrate mold into molten semiconducting material, solidifying the molten semiconducting material onto an external surface of the shell material, and removing the solidified semiconducting material from the substrate mold.

In yet further exemplary embodiments of the disclosure are provided articles of semiconducting material made according to methods of the disclosure.

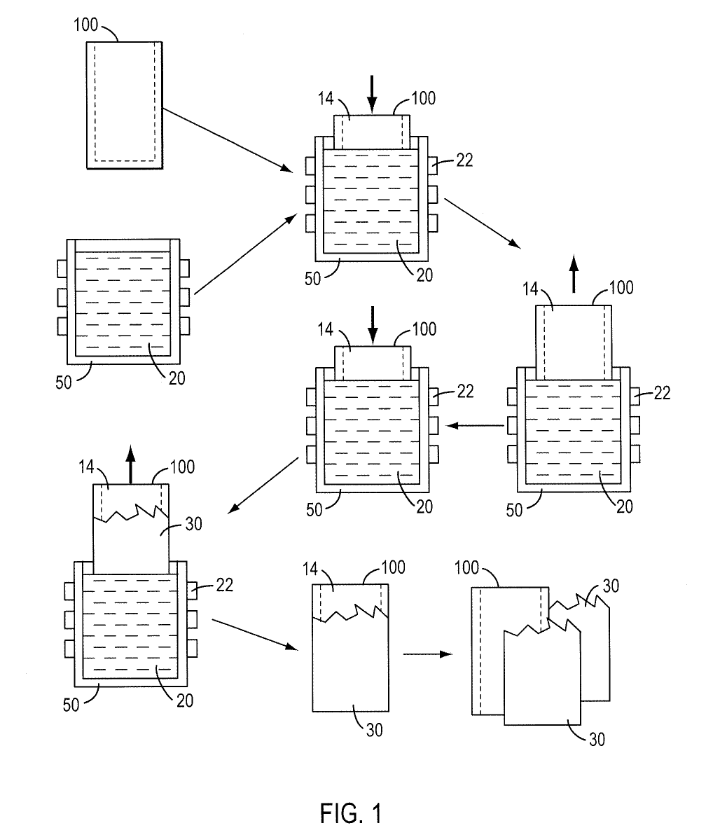

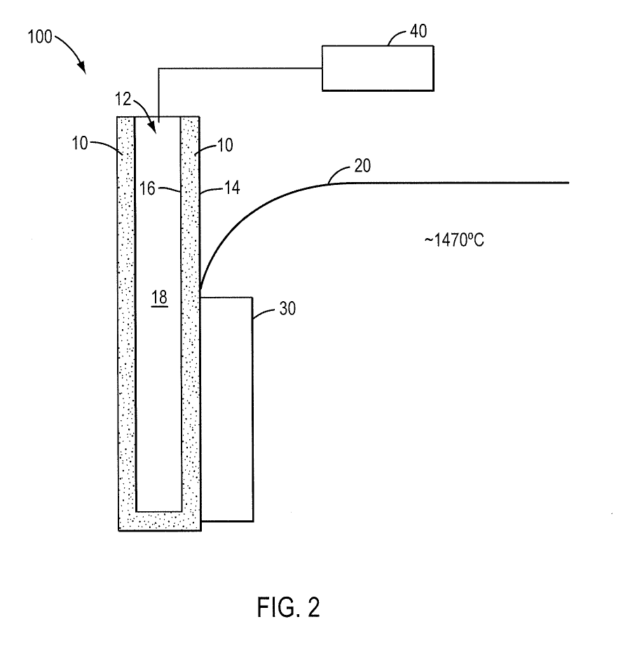

FIG. 1 is a schematic illustration of an exemplary method of making an article of semiconducting material according to an embodiment. The exemplary method is an exocasting process, which casts the article over an exterior surface of a mold, rather than within an internal mold cavity. FIG. 2 is a schematic illustration of an exemplary substrate mold and a method of making an article of semiconducting material, according to an embodiment. A substrate mold 100 is provided which is hollow, which comprises a shell material 10 and a core 12 defined within and internal to the shell material 10. The shell material 10 is outside of the core 12 defined therein, and includes an external surface 14 facing away from the core 12 and an internal surface 16 facing toward the core 12.

As shown in FIG. 1, the substrate mold 100 is immersed in molten semiconducting material 20. The molten semiconducting material 20 such as, for example, molten silicon, may be provided by melting silicon in a vessel 50, such as a crucible, which may optionally be non-reactive with the silicon. The semiconducting material 20 may be heated by a heating source 22. After the substrate mold 100 is provided within the molten semiconducting material 20, the molten semiconducting material 20 is eventually solidified, after a cooling process as will be described below, as solidified semiconducting material 30 onto the external surface 14 of the shell material 10, which engages with the molten semiconducting material 20. Thereafter, the substrate mold 100 is removed from the molten semiconducting material 20 and the solidified semiconducting material 30 is removed from the substrate mold 100.

The internal surface 16 of the shell material 10 is configured as a thermal transfer surface to transfer heat therethrough. The core 12 that is defined within the shell material 10 is configured to remove heat from the shell material 10 through the thermal transfer surface 16 of the shell material 10. Thus, as will be discussed below, when cooling occurs by inserting a core material 18, for example, within the core 12, heat is transferred from the shell material 10 through the inner, thermal transfer surface 16 of the shell material 10 to the core 12.

According to at least one embodiment, a temperature of the shell material 10 is initially at an initial temperature Tₘₑₗₜ and is then heated to a heated temperature Tₕₑₐₜ prior to immersion into the molten semiconducting material 20. The heated temperature Tₕₑₐₜ of the shell material 10 can be greater than a heated temperature Tₘₑₗₜ of the molten semiconducting material 20. When the molten semiconducting material 20 is silicon, for example, Tₘₑₗₜ is in a range from about 1410° C. to about 1414° C. In a subsequent operation, the substrate mold 100 is immersed into the molten semiconducting material 20 and an ideal initial condition may be achieved, which is a condition in which none of the molten semiconducting material 20 is solidified and maintained on the shell material 10. In this embodiment, the ideal initial condition is a condition in which the molten semiconducting material does not initially solidify onto the external surface 14 of the shell material 10 after the substrate mold 100 is immersed into the molten semiconducting material 20. Because the temperature of the shell material 10 is heated to a temperature Tₕₑₐₜ that is greater than that of the temperature Tₘₑₗₜ of the molten semiconducting material 20, then the molten semiconducting material 20 does not solidify onto the external surface 14 of the shell material 10 when the substrate mold 100 is initially immersed in the molten semiconducting material 20.

In an alternative exemplary embodiment, the shell material 10 is not pre-heated prior to being immersed in the molten semiconducting material 20. The substrate mold 100 is immersed for a time sufficient to reduce the temperature of the molten material in close proximity to the external surface 14 of the shell material 10 to the solidification point of the molten semiconducting material 20, and to remove sufficient heat from the molten semiconducting material 20 to immediately solidify at least a portion of the semiconducting material. As the substrate mold 100 is immersed, the semiconducting material that immediately solidifies onto the external surface 14 of the shell material 10 is formed with dendritic morphology in the planar direction and the planar morphology in the normal direction, which generally occurs in known exocasting processes.

In another exemplary embodiment, the temperature of the external surface 14 of the shell material 10 may be, for example, slightly below the temperature Tₘₑₗₜ of the molten semiconducting material, but still achieve the ideal initial condition, in which none of the molten semiconducting material 20 is solidified and maintained on the shell material 10, without an initial solidification. For example, as the temperature of the external surface 14 of the shell material 10 is slightly below the temperature Tₘₑₗₜ of the molten semiconducting material, there is not enough of a temperature gradient to result in an initial solidification of the molten semiconducting material 20. Therefore, the ideal initial condition may be achieved merely by providing the external surface 14 of the shell material 10 at a temperature that is close to the temperature Tₘₑₗₜ of the molten semiconducting material 20, e.g., slightly below the temperature Tₘₑₗₜ, without requiring either the pre-heating of the shell material 10 or the remelting condition after an initial solidification of the molten semiconducting material 20.

Thereafter, in contrast to known exocasting processes, the substrate mold 100 remains immersed in the molten semiconducting material 20 until an ideal initial condition for wafer formation is achieved. The ideal initial condition occurs after the substrate mold 100 remains immersed for a time sufficient for the solidified semiconducting material 30 to remelt and the substrate mold 100 to reach a temperature such that the temperature of the mold 100 may equilibrate with the temperature Tₘₑₗₜ of the molten semiconducting material 20. The initially solidified semiconducting material 30 may remelt within, e.g., 5-30 sec, depending on the initial, pre-immersed, temperature of the shell material 12 and the thickness of the shell material 12, for example. When no semiconducting material 20 is maintained on the external surface 14 of the shell material 10, the ideal initial condition for the formation of the wafer has been achieved. For a further description of one exemplary embodiment of the remelting process, reference is made to U.S. Pat. No. 7,771,643.

Once the ideal initial condition is achieved according to either of the foregoing exemplary embodiments, solidification can be started in a more controlled manner by cooling the substrate mold 100 from within the core 12 of the substrate mold 100. Cooling may occur by inserting a core material 18 within the core 12. The core material 18 may be inserted at various preheat temperatures to control heat removal. In one embodiment, the core material 18 may have a lower temperature than a temperature of the shell material 10 after the ideal initial condition is achieved. In this embodiment, for example, the core material 18 has a temperature that is lower than the temperature Tₕₑₐₜ of the shell material 10 prior to immersion in the molten semiconducting material 20. As the core material 18 is at a lower temperature than that of the heated temperature Tₕₑₐₜ of the shell material 10, when the core material 18 inserted into the core 12, after the substrate mold 100 is immersed in the molten semiconducting material 20, heat is transferred from the shell material 10 to the core material 18 due to the temperature gradient between the shell material 10 and the core material 18. When the temperature of the shell material 10 decreases to below the melting temperature Tₘₑₗₜ of the molten semiconducting material 20, the solidification process starts. As the solidification process does not begin on the external surface 14 of the shell material 10 as soon as the substrate mold 100 is immersed in the molten semiconducting material 20, the formation of the solidified semiconducting material along the plane of the external surface 14 of the shell material 10 is avoided and the solidification direction is confined in the normal direction of the external surface 14 of the shell material. In an alternative embodiment, the core material 18 having a lower temperature than a temperature of the shell material 10 is provided within the core 12 prior to immersing the substrate mold 100 into the molten semiconducting material 20.

The shell material 10 may comprise any material suitable for the described process. For example, the shell material 10 may comprise a refractory material, such as, but not limited to, silica.

The core material 18 may comprise any material that is suitable for transferring heat from the shell material. For example, the core material may comprise a solid material of appropriate conductivity, heat capacity and thickness, such as but not limited to silica, tungsten, silicon carbide, and aluminum oxide, or any combination thereof. The core material 18 may, as a further example, comprise a heat transfer fluid or a heat transfer gas.

Either one of the shell material 10 or the core material 18 may have characteristics that allow for the manipulation of the heat flux to cause solidification of the molten semiconducting material onto the external surface 14 of the shell material 10. For example, the thickness, the conductivity, the heat capacity of the material, the shape of the material, and the length of time that the material is heated are all examples of characteristics that may affect the heat flux. As an example, the shell material 10 and the core material 18 may be made from the same material, e.g., silica, but may each have different thicknesses, e.g., a thin shell material 10 and a thick core material 18. The varying thickness of the materials 10 and 18 may result in heat transfer from the shell material 10 to the core material 18 due to a temperature gradient when the temperature of the shell material 10, which is in closer proximity to the heated molten semiconducting material 20, is raised in comparison to the temperature of the thicker core material 18.

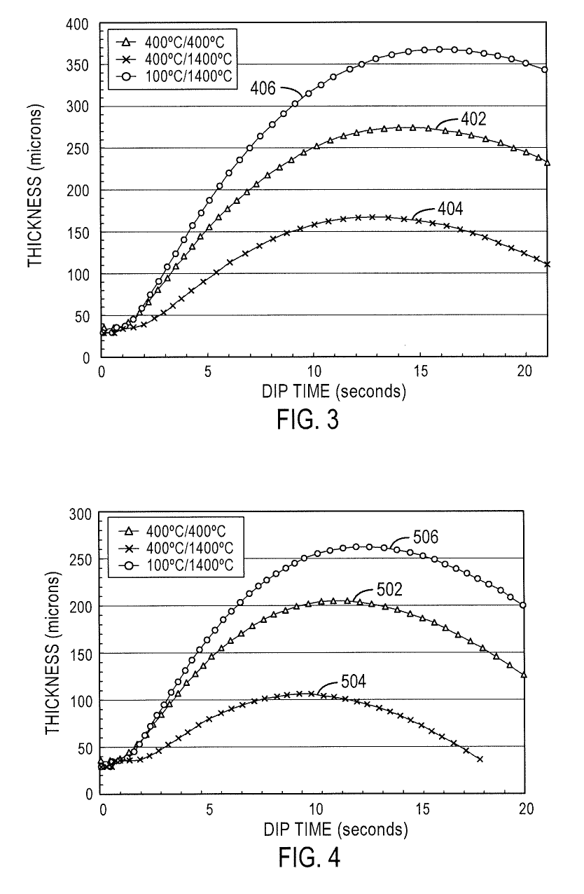

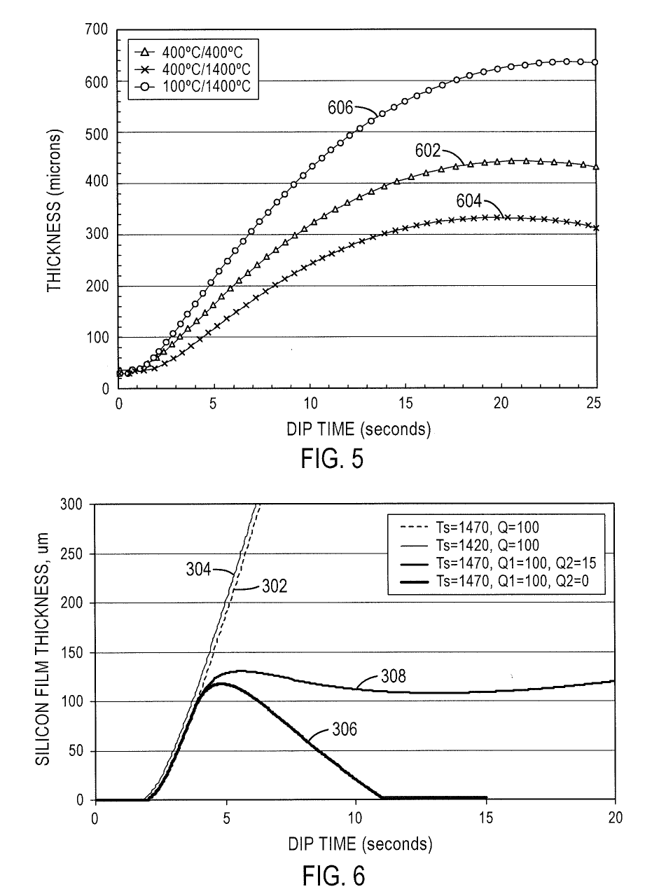

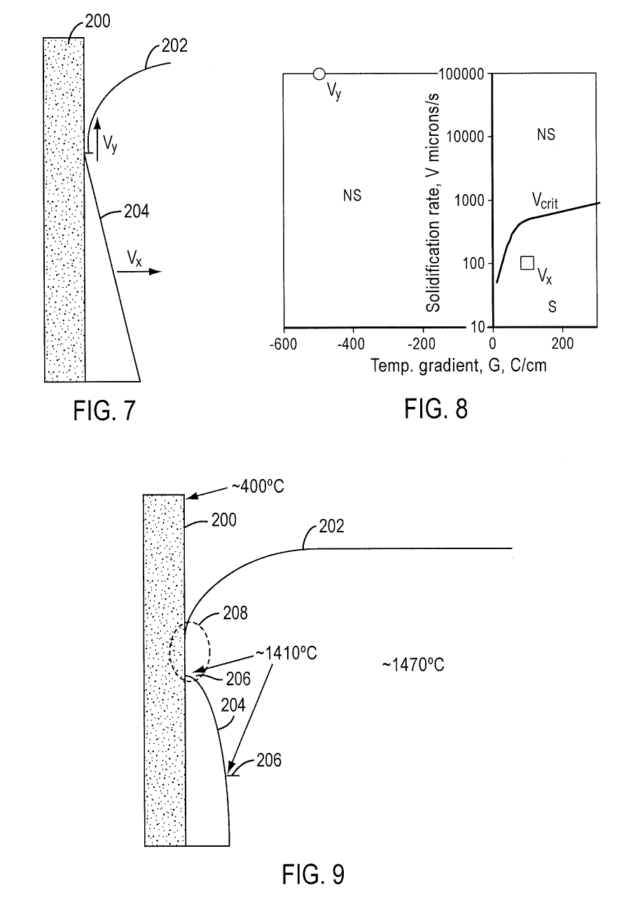

FIGS. 3-5 are calculated plots of the thickness of a silicon article, at various starting temperatures of a shell material and respective core materials of tungsten, silicon carbide, and aluminum oxide, formed as a function of the immersion time in molten silicon according to at least one exemplary embodiment of the disclosure. Each of the curves 402, 502 and 602 in FIGS. 3-5 illustrate the thickness of the solidified material when the preheat temperature of both the shell material 10 and the core material 18 is 400° C. The curves 402, 502 and 602 are defined in the key with the reference 400° C./400° C., which are the respective core and shell temperatures.

Each of the curves 404, 504 and 604 in FIGS. 3-5 illustrate the thickness of the solidified material when the preheat temperature of the shell material 10 is 1400° C. and the preheat temperature of the core material 18 is 400° C. The corresponding keys contain the reference 400° C./1400° C. to indicate the core and shell temperature, respectively.

Each of the curves 406, 506 and 606 in FIGS. 3-5 illustrate the thickness of the solidified material when the preheat temperature of the shell material 10 is 1400° C. and the preheat temperature of the core material 18 is 100° C. When the temperature of the shell material 10 is at 1400° C., a desired thickness of silicon as the solidified material may be formed in a desired time, for example, about 100 microns or greater, such as about 200 microns or greater, and within about 20 seconds or less. The corresponding keys contain the reference 100° C./1400° C. to indicate the core and shell temperature, respectively.

The substrate mold 100 may, in at least some exemplary embodiments, be actively cooled by the core material 18. In embodiments, the heat flux between the core material 18 and the shell material 12 may be controlled by such actively cooling. For example, when the core material 18 is a heat transfer fluid, the heat flux (W/cm²) can be controlled by controlling one or more of the heat transfer coefficient, which is a function of temperature, the flow rate of the heat transfer fluid within the core 12, and the design of the core 12. The heat flux may be changed directly by the entry temperature of the heat transfer fluid. The flux is approximately h (T-T_{f}), where T_{f} is the temperature of the entry fluid, and h is a function of flow rate, temperature and core design.

In yet another exemplary embodiment, the core material 18 may be a conductive material, such as copper, which is connected with an active cooling device 40. The cooling device 40 may be controlled to change a temperature of the conductive material in order to control the heat flux between the core material 18 and the shell material 12. Alternatively, the core material 18 may be an alloy cooled by Peltier effect.

An active cooling process allows for solidification of the molten semiconducting material 20 to be controlled and, when desired, to take place slowly, which may be beneficial in the formation of the solidified material 30. Once the material has solidified, the substrate mold 100 is extracted from the molten semiconducting material 20 and the solidified material, e.g., a wafer, such as a silicon wafer, is removed from the external surface 14 of the substrate mold 100.

FIG. 6 is a calculated plot of the thickness of a silicon article at various starting temperatures and various heat flux levels formed as a function of the immersion time in molten silicon according to at least one exemplary embodiment. Curve 302 illustrates the substrate mold 100 starting with an initial temperature of 1470° C. (equilibrated with the melt) and a constant heat flux of 100 W/cm². In this case, the solidification does not start until approximately 2.5 seconds. This is due to the fact that within this time, the heat flux was utilized in reducing the sensible heat of the shell material 10 of the substrate mold 100. Once the surface of the substrate mold 100 is below the melting point of silicon, 1410° C., solidification into the melt initiates. Thereafter, the resolidification process occurs at almost a constant rate. Graph 304 illustrates the substrate mold 100 starting with an initial temperature of 1420° C. In this case, solidification starts earlier than at an initial temperature of 1470° C. As long as the cooling heat flux is kept constant, solidification will continue almost at a constant rate.

Graphs 306 and 308 illustrate the use of variable heat flux. Graph 306 corresponds to solidification under a constant heat flux of 100 W/cm² at an initial temperature of 1470° C. until the target thickness, e.g., 100 microns, is reached, followed by instantaneously turning off the heat flux by, for example, shutting off the cooling fluid flow. From this point onwards, there will be remelt of the silicon film.

Graph 308 corresponds to solidification at a constant heat flux of 100 W/cm² at an initial temperature of 1470° C. until a target thickness, e.g., 125 microns, is reached, followed by setting the cooling heat flux to 15 W/cm². Thus, by choosing the cooling heat flux, the shape (i.e., slope) of the thickness versus time curve can be controlled, which can lead to small thickness variability due to process condition fluctuation.

Unless otherwise indicated, all numbers used in the specification and claims are to be understood as being modified in all instances by the term “about,” whether or not so stated. It should also be understood that the precise numerical values used in the specification and claims form additional embodiments. Efforts have been made to ensure the accuracy of the numerical values disclosed in the Examples. Any measured numerical value, however, can inherently contain certain errors resulting from the standard deviation found in its respective measuring technique.

As used herein the use of “the,” “a,” or “an” means “at least one,” and should not be limited to “only one” unless explicitly indicated to the contrary. Thus, for example, the use of “the shell material” or “shell material” is intended to mean at least one shell material.

Other embodiments will be apparent to those skilled in the art from consideration of the specification and practice of the disclosure disclosed herein. It is intended that the specification and examples be considered as exemplary only, with a true scope and spirit of the disclosure being indicated by the claims.

What is claimed is:

1. A method of making an article of semiconducting material, said method comprising:
providing a substrate mold having a shell material and a core defined within the shell material and configured to remove heat from the shell material;
immersing the substrate mold into molten semiconducting material;
solidifying the molten semiconducting material onto an external surface of the shell material; and
removing the solidified semiconducting material from the substrate mold.

2. The method according to claim 1, wherein the step of immersing is maintained until an ideal initial condition is achieved, the ideal initial condition being where none of the molten semiconducting material is solidified and maintained on the external surface of the shell material.

3. The method according to claim 2, further comprising heating the shell material to a heated temperature Tₕₑₐₜ before immersing the substrate mold, wherein the heated temperature Tₕₑₐₜ is greater than a heated temperature Tₘₑₗₜ of the molten semiconducting material.

4. The method according to claim 3, wherein the molten semiconducting material does not initially solidified onto the substrate mold after immersing the substrate mold into the molten semiconducting material.

5. The method according to claim 2, further comprising maintaining the substrate mold immersed in the molten semiconducting material until a portion of the molten semiconducting material solidifies onto the external surface of the shell material and then entirely remelts into the molten semiconducting material in order to achieve the ideal initial condition.

6. The method according to claim 2, further comprising actively cooling the substrate mold from the core after the ideal initial condition is achieved.

7. The method according to claim 5, wherein actively cooling the substrate mold comprises a step of introducing a core material within the core.

8. The method according to claim 7, wherein the step of introducing the core material comprises providing a core material having a lower temperature than a temperature of the shell material.

9. The method according to claim 7, wherein the step of introducing the core material comprises providing a core material having a lower temperature than a temperature of the shell material prior to the step of immersing the substrate mold.

10. The method according to claim 7, wherein the actively cooling the substrate mold comprises controlling a heat flux between the core material and the shell material.

11. The method according to claim 10, wherein the core material provided is a heat transfer fluid, and wherein the step of controlling the heat flux comprises controlling the flow rate of the heat transfer fluid.

12. The method according to claim 10, wherein the step of controlling the heat flux comprises controlling the heat flux to be variable to vary a thickness of a solidified portion of the molten semiconducting material.

13. The method according to claim 10, wherein the step of controlling the heat flux comprises controlling the heat flux to be substantially constant in order to solidify the molten semiconducting material onto the outer surface of the shell material at a substantially constant rate.

14. The method according to claim 1, wherein the shell material is heated to a heated temperature Tₕₑₐₜ less than a heated temperature Tₘₑₗₜ of the molten semiconducting material, prior to immersing the substrate mold.

15. The method according to claim 1, wherein solidifying the molten semiconducting material comprises solidifying the molten semiconducting material only in a direction substantially normal to the external surface of the shell material.

16. A substrate mold, comprising:
a shell material having an external surface configured to engage with molten semiconducting material, and an internal surface configured as a thermal transfer surface to transfer heat therethrough; and
a core defined within the shell material and configured to remove heat from the shell material through the thermal transfer surface of the shell material,
wherein the substrate mold is configured to be immersed in the molten semiconducting material, and the external surface of the shell material is configured to have solidified molten semiconducting material formed thereon.

17. The substrate mold according to claim 16, further comprising a core material provided into the core.

18. The substrate mold according to claim 17, wherein the core material comprises a heat transfer fluid.

19. The substrate mold according to claim 17, wherein the core material comprises at least one of silica, tungsten, silicon carbide, and aluminum oxide.

20. The substrate mold according to claim 17, wherein the core material comprises a heat transfer gas.

21. The substrate mold according to claim 17, wherein the core material comprises a conductive material connected with an active cooling device, the active cooling device being controlled to change a temperature of the conductive material to control a heat flux between the core material and the shell material.

22. The substrate mold according to claim 17, wherein the core material comprises an electrically connected alloy.
